(19) United States
(12) Patent Application Publication
(10) Pub. No.: US 2025/0176069 A1
(43) Pub. Date: May 29, 2025

(54) SYSTEM AND METHOD FOR PROVIDING EMERGENCY MESSAGES TO EMERGENCY CONTACTS

(71) Applicant: Verizon Patent and Licensing Inc., Basking Ridge, NJ (US)

(72) Inventors: Kashif Khan, Keller, TX (US); Shawn Pugh, Easton, PA (US); Shujaat A Siddique, Hillsborough, NJ (US); John C Vinh Nguyen, Trophy Club, TX (US)

(21) Appl. No.: 18/522,573

(22) Filed: Nov. 29, 2023

(51) Int. Cl. H04W 76/50; H04W 4/48; H04W 8/20

(52) U.S. Cl. CPC H04W 76/50; H04W 4/48; H04W 8/20

(57) ABSTRACT

In an example, an emergency communication session request is received from a first user equipment (UE). In response to the emergency communication session request, a communication session between the first UE and a first public safety answering point (PSAP) may be established. In response to the emergency communication session request, a first emergency message may be provided to an emergency contact of the first UE.

### BACKGROUND

In an emergency, an individual may place a call to an emergency service. Some systems support automatic establishment of the call in response to detecting the emergency, such as in the event of a vehicular accident.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a diagram illustrating a system for providing emergency messages to emergency contacts in accordance with an embodiment.

FIG. 2 is a flow chart illustrating a method for providing emergency messages to emergency contacts in accordance with an embodiment.

FIG. 3 is a diagram illustrating display of an emergency alert provisioning interface in accordance with an embodiment.

FIG. 4 is a diagram illustrating a scenario associated with registration of a user equipment (UE) with a network in accordance with an embodiment.

FIG. 5 is a diagram illustrating a scenario associated with establishing a communication session between a UE and a first public safety answering point (PSAP) in accordance with an embodiment.

FIG. 6 is a diagram illustrating a scenario associated with providing emergency messages to emergency contacts in accordance with an embodiment.

FIG. 7 is a diagram illustrating a Serving Call Session Control Function (S-CSCF)-based architecture in accordance with an embodiment.

FIG. 8 is a diagram illustrating a network architecture of a system for emergency services in accordance with an embodiment.

FIG. 9 is a diagram illustrating a network architecture of a system for emergency services in accordance with an embodiment.

FIG. 10 is an illustration of an example environment in which at least a portion of the techniques presented herein may be utilized and/or implemented.

FIG. 11 is an illustration of an example network that may utilize and/or implement at least a portion of the techniques presented herein.

FIG. 12 is an illustration of a scenario featuring an example non-transitory machine-readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

One or more systems and/or techniques for providing emergency messages to emergency contacts are provided. In the event of an accident (e.g., a vehicular accident), a UE (e.g., an emergency call (eCall) equipped vehicle) may establish an emergency communication session (e.g., an emergency voice call) with a corresponding public safety answering point (PSAP). In accordance with some embodiments herein, the PSAP may also be provided with an emergency message (e.g., a minimum set of data (MSD)) indicating key information associated with the accident, such as at least one of a quantity of occupants of the vehicle, a time of the vehicular accident, a location of the vehicular accident, a travel direction of the vehicle, etc.

In accordance with some embodiments of the present disclosure, one or more emergency contacts (e.g., family members, relatives, a support team of a company, etc.) are notified of the accident (e.g., automatically and/or without manual intervention), which may be especially important and/or beneficial in situations where (i) occupant(s) of the vehicle are unconscious, (ii) occupant(s) of the vehicle are incapable of notifying the emergency contacts themselves (e.g., due to injury, etc.), or (iii) occupant(s) of the vehicle are in need of immediate support. For example, in response to receiving an emergency communication session request from the UE (which may be transmitted by the UE upon detecting the accident), a network may transmit one or more emergency messages (comprising at least a subset of the MSD, for example) to the one or more emergency contacts to notify them of the vehicular accident. In an example where an emergency contact is a support team (e.g., a support team of an employer associated with the UE), the support team may be notified of where and when the accident occurred, and can thus facilitate transfer of resources to the user and/or the vehicle. Alternatively and/or additionally, an emergency contact (e.g., a family member, a friend, the support team, etc.) may take steps to assist the user after the vehicular accident (e.g., by contacting emergency services, going to the location of the vehicular accident, contacting a hospital close to the vehicular accident to provide insurance information for treating the user, etc.).

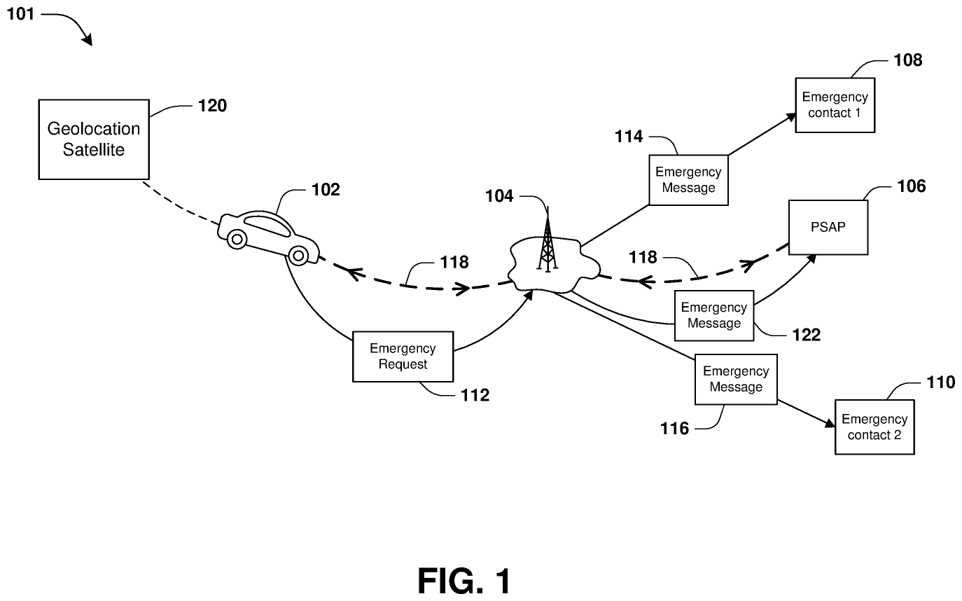

FIG. 1 illustrates an example of a system 101 for providing emergency messages to emergency contacts. In some examples, the system 101 comprises a UE 102, a network 104 and/or one or more geolocation satellites 120. The UE 102 may be associated with a vehicle, such as at least one of a car, a truck, an aerial vehicle (e.g., a personal air vehicle (PAV), a helicopter, etc.), etc. For example, the UE 102 may be an in-vehicle system (IVS) UE of the vehicle. Alternatively and/or additionally, the UE 102 may comprise at least one of a smart phone, a laptop computer, a tablet computer, a wearable device, etc. The UE 102 may be disposed in the vehicle.

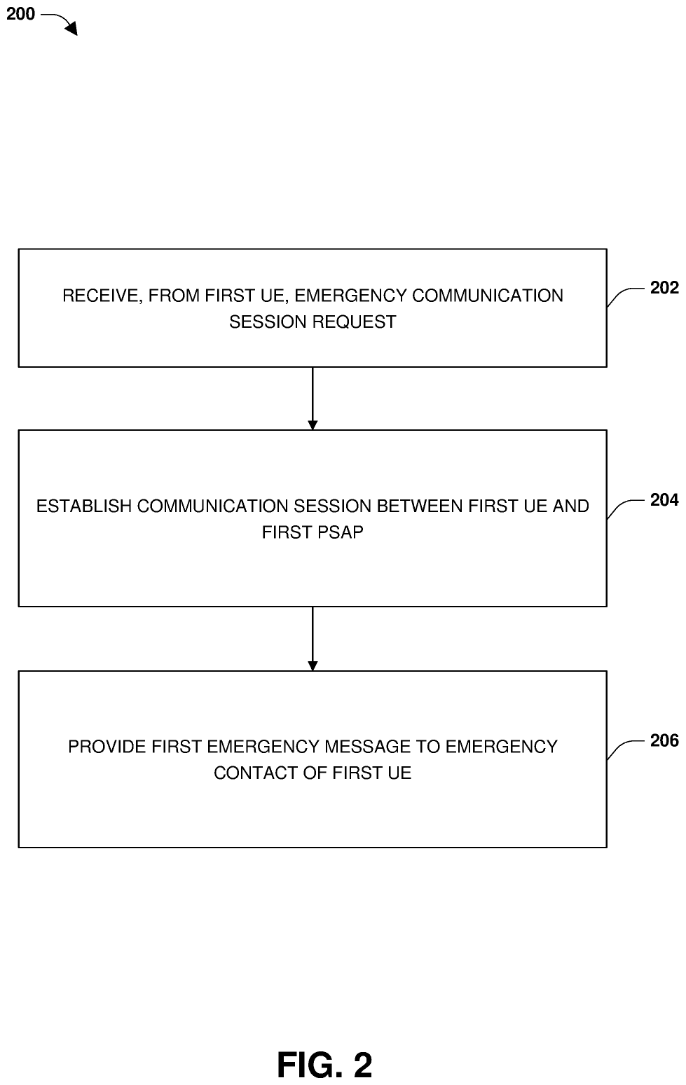

An embodiment of providing emergency messages to emergency contacts is illustrated by an example method 200 of FIG. 2, and is further described in conjunction with FIG. 1. At 202 of FIG. 2, an emergency system (comprising at least some of the network 104, for example) may receive an emergency communication session request 112 (shown in FIG. 1) from the UE 102. In some examples, the network 104 comprises an originating network (e.g., an originating telecommunication site, a base station, a gNB, an eNB, etc.) to which the UE 102 is connected (e.g., proximately connected). In some examples, the UE 102 may transmit the emergency communication session request 112 to the network 104 in response to a vehicular accident associated with the vehicle and/or the UE 102. For example, the UE 102 may transmit the emergency communication session request 112 to the network 104 automatically (and/or without user intervention) in response to detecting (using a sensor of the UE 102 and/or the vehicle, for example) the vehicular accident (e.g., a collision with another vehicle, a single-vehicle accident, a rollover accident, etc.). Embodiments are contemplated in which the emergency communication session request 112 is transmitted in response to an event other than a vehicular accident, such as another type of accident, a health emergency, a household emergency, etc. Alternatively and/or additionally, the UE 102 may transmit the emergency communication session request 112 to the network 104 in response to a user of the UE 102 manually triggering the emergency communication session request 112. For example, the user may manually trigger the emergency communication session request 112 by pressing a button (e.g., emergency call SOS button) of the UE 102 and/or the vehicle.

At 204 of FIG. 2, the emergency system may establish a communication session 118 (shown in FIG. 1) between the UE 102 and a first public safety answering point (PSAP) 106. For example, the emergency system (e.g., the network 104) may establish the communication session 118 in response to the emergency communication session request 112. At 206 of FIG. 2, the emergency system (e.g., the network 104) may provide a first emergency message 114 to a first emergency contact 108. For example, the emergency system may provide the first emergency message 114 to the first emergency contact 108 in response to the emergency communication session request 112. In some examples, acts 204 and 206 may be performed concurrently. Embodiments are contemplated in which acts 204 and 206 are not performed concurrently (e.g., acts 204 and 206 may be performed sequentially, such as one after the other, where act 204 is performed before act 206, or act 206 is performed before act 204).

In some examples, the emergency communication session request 112 may correspond to an emergency call (eCall) which may be implemented in accordance with one or more standards and/or specifications including RFC 8148 “Next-Generation Vehicle-Initiated Emergency Calls”, RFC 7135 “Registering a SIP Resource Priority Header Field Namespace for Local Emergency Communications” and/or one or more other standards and/or specifications. In some examples, the UE 102 and/or the network 104 may communicate (e.g., with each other and/or with the first PSAP 106) according to the one or more standards and/or specifications.

In some examples, the first PSAP 106 may be determined based upon a location of the UE 102 (e.g., a current location of the UE 102 and/or a location of the UE 102 at a time of the vehicular accident). In some examples, the location of the UE 102 may be determined using satellite-based data determined using one or more geolocation satellites 120 (e.g., the location of the UE 102 may be based upon geolocation signals transmitted by the one or more geolocation satellites 120). The first PSAP 106 may be selected from among a plurality of PSAPs associated with various geographical regions based upon the first PSAP 106 being associated with a first geographical region comprising the location of the UE 102. For example, the first PSAP 106 may be used for fielding emergency calls and/or providing emergency services for users in the first geographical region.

The communication session 118 may comprise a voice call and/or a video call. In some examples, during the communication session 118, the user of the UE 102 converses with an emergency service agent of the first PSAP 106 (e.g., the emergency service agent may be at least one of a call-center employee, a robot, etc.). For example, during the communication session 118, the emergency service agent may guide the user through a series of questions to obtain information (from the user) about the vehicular accident and/or to dispatch responders (e.g., emergency medical personnel, firefighters, police, manpower, etc.) to the vehicular accident.

In some examples, the network 104 may provide a PSAP emergency message 122 (which may also be referred to as “minimum set of data (MSD)”) to the first PSAP 106 in response to the emergency communication session request 112. For example, the PSAP emergency message 122 may be indicative of accident information about the vehicular accident. The PSAP emergency message 122 may be indicative of (i) a quantity of occupants of the vehicle, (ii) a time of the vehicular accident, (iii) a location of the vehicular accident, (iv) a travel direction of the vehicle, (v) a vehicle description of the vehicle (e.g., vehicle make, model and/or color), (vi) an initiation method of the emergency communication session request 112 (e.g., whether the emergency communication session request 112 was triggered automatically without user intervention or manually by use of the button, for example) and/or (vii) one or more other attributes associated with the first vehicular accident.

In some examples, the network 104 may maintain and/or access a first subscriber profile associated with the UE 102. The first subscriber profile may be stored on a subscriber profile database. In some examples, the subscriber profile database is implemented on a Home Subscriber Server (HSS) of the network 104. In some examples, the first subscriber profile may be indicative of (i) a set of (one or more) emergency contacts of the UE 102, and/or (ii) authorization to share a set of (one or more) attributes with the set of emergency contacts. In some examples, the network 104 transmits an emergency message to each emergency contact indicated by the first subscriber profile. In an example, the set of emergency contacts of the first subscriber profile include the first emergency contact 108 and a second emergency contact 110 (shown in FIG. 1). Based upon the set of emergency contacts of the first subscriber profile, the network 104 may provide (i) the first emergency message 114 to the first emergency contact 108 and (ii) a second emergency message 116 to the second emergency contact 110.

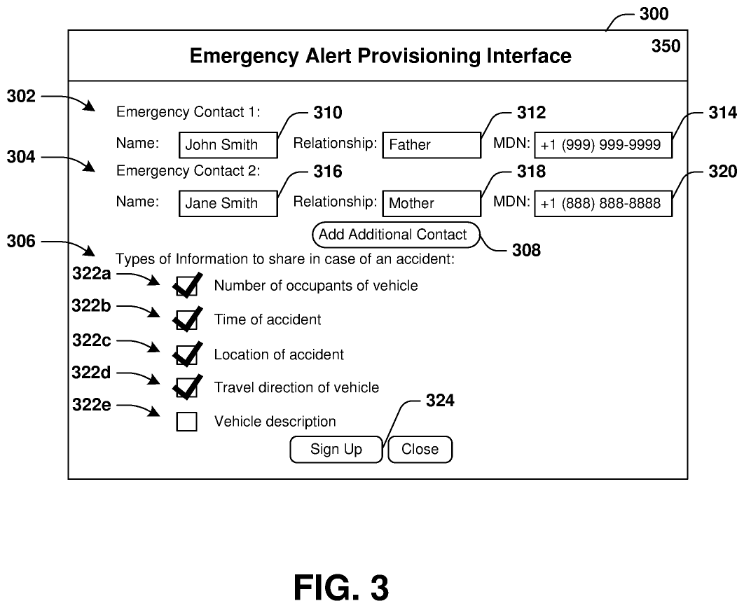

FIG. 3 illustrates display of an emergency alert provisioning interface 350 used to provision the set of emergency contacts of the UE 102 and/or the set of attributes to the first subscriber profile. The emergency alert provisioning interface 350 may be displayed on a client device 300, which may comprise the UE 102 and/or another device (belonging to the user of the UE 102, for example). The emergency alert provisioning interface 350 may comprise a first emergency contact entry interface 302 for submitting a first emergency contact entry associated with the first emergency contact 108, a second emergency contact entry interface 304 for submitting a second emergency contact entry associated with the second emergency contact 110, a selectable input 308 for adding one or more additional emergency contacts (in addition to the first emergency contact 108 and/or the second emergency contact 110, for example) to the set of emergency contacts, and/or an attribute provisioning interface 306 for configuring the set of attributes.

The first emergency contact entry interface 302 may include a text field 310 for submitting a name of the first emergency contact 108, a text field 312 for submitting a relationship of the first emergency contact 108 with the user of the UE 102, and/or a text field 314 for submitting a first destination address (e.g., at least one of a first mobile directory number (MDN), a first email address, etc.) of the first emergency contact 108. The second emergency contact entry interface 304 may include a text field 316 for submitting a name of the second emergency contact 110, a text field 318 for submitting a relationship of the second emergency contact 110 with the user of the UE 102, and/or a text field 320 for submitting a second destination address (e.g., at least one of a second MDN, a second email address, etc.) of the second emergency contact 110. The attribute provisioning interface 306 may include one or more check boxes 322a-322e (e.g., tick boxes) used for selecting a set of (one or more) authorized attributes from a plurality of attributes that the user authorizes the network 104 to share with the set of emergency contacts in the event of an emergency. For example, a check may be displayed overlaying a check box based upon a selection of the check box. In an example, the user may select check box 322a to authorize sharing a first attribute (e.g., quantity of occupants of the vehicle) with the set of emergency contacts.

In an example shown in FIG. 3, the set of authorized attributes may include the first attribute (e.g., quantity of occupants of the vehicle), a second attribute (e.g., time of an accident), a third attribute (e.g., location of an accident), and/or a fourth attribute (e.g., travel direction of the vehicle) due to corresponding check boxes 322a-322d being selected. Alternatively and/or additionally, the set of authorized attributes may not include a fifth attribute (e.g., vehicle description of the vehicle) due to corresponding check box 322e not being selected (e.g., not selecting the check box 322e may indicate that the user does not authorize sharing the fifth attribute with the set of emergency contacts).

In some examples, emergency alert provisioning information (comprising the first emergency contact entry, the second emergency contact entry and/or the set of authorized attributes, for example) may be received from the client device 300 in response to a selection of a selectable input 324 of the first emergency contact entry interface 302. The first subscriber profile may be generated based upon the emergency alert provisioning information. For example, the first subscriber profile may be generated to include the first emergency contact 108 and/or the second emergency contact 110. For example, for each emergency contact of the set of emergency contacts, the first subscriber profile may be indicative of a name, a relationship with the user and/or a destination address (e.g., an MDN, an email address, etc.) associated with the emergency contact. Alternatively and/or additionally, the first subscriber profile may be indicative of the set of authorized attributes. The first subscriber profile may be stored in the subscriber profile database in response to generating the first subscriber profile.

In some examples, the network 104 may retrieve the first subscriber profile associated with the UE 102 from the subscriber profile database in response to the emergency communication session request 112. The network 104 may determine the set of emergency contacts (e.g., the first emergency contact 108 and/or the second emergency contact 110) based upon the first subscriber profile. For example, the network 104 may determine a set of destination addresses (e.g., one or more MDNs, one or more email addresses, etc.) of the set of emergency contacts based upon the first subscriber profile. The network 104 may transmit an emergency message (e.g., the first emergency message 114, the second emergency message 116, etc.) to each emergency contact of the set of emergency contacts (e.g., the network 104 may transmit an emergency message to each destination address of the set of destination addresses). In an example, the first emergency message 114 may be generated based upon the first subscriber profile. For example, the first emergency message 114 may be generated to include values of the set of authorized attributes (and/or the first emergency message 114 may not include values of attributes not included in the set of authorized attributes).

In an example, the set of authorized attributes include the first attribute (e.g., quantity of occupants of the vehicle during the vehicular accident), the second attribute (e.g., time of the vehicular accident), the third attribute (e.g., location of the vehicle and/or the vehicular accident) and/or the fourth attribute (e.g., travel direction of the vehicle during or leading up to the vehicular accident). In the example, the first emergency message 114 may be generated to include a first value (e.g., two occupants) of the first attribute, a second value (e.g., 2:03 AM) of the second attribute, a third value (e.g., Tulsa, Oklahoma, 36.1540° N, 95.9928° W) of the third attribute and/or a fourth value (e.g., east) of the fourth attribute. In some examples, content of the second emergency message 116 provided to the second emergency contact 110 may at least partially match content of the first emergency message 114 provided to the first emergency contact 108.

The first emergency message 114 may inform the first emergency contact that the user of the UE 102 was involved in the vehicular accident and/or may provide surrounding details of the vehicular accident (in accordance with the set of authorized attributes, for example). In an example, the first emergency message 114 may comprise “John Smith was involved in a car accident at 2:03 AM in Tulsa, Oklahoma, 36.1540° N, 95.9928° W while the car was traveling east and there were two occupants in the car”.

In an example, the first emergency message 114 comprises a first text message (e.g., a Short Message/Messaging Service (SMS) message, a multimedia messaging service (MMS) message, etc.). The network 104 may transmit the first text message to the first MDN (of the first emergency contact 108). Alternatively and/or additionally, the network 104 may transmit the second emergency message 116 (e.g., a second text message) to the second MDN (of the second emergency contact 110).

In an example, the first emergency message 114 comprises a first email message. The network 104 may transmit the first email message to the first email address (of the first emergency contact 108). Alternatively and/or additionally, the network 104 may transmit the second emergency message 116 (e.g., a second email message) to the second email address (of the second emergency contact 110).

In some examples, the first emergency message 114 comprises at least some content of the PSAP emergency message 122 (provided to the first PSAP 106). In some examples, the PSAP emergency message 122 comprises values of some or all of the plurality of attributes. In some examples, the PSAP emergency message 122 comprises a value of an attribute (e.g., the fifth attribute) that is not included in the set of authorized attributes. In an example, when the fifth attribute is not included in the set of authorized attributes, the PSAP emergency message 122 comprises a fifth value (e.g., White Ford Focus) of the fifth attribute (e.g., vehicle description of the vehicle), whereas the first emergency message 114 may not comprise the fifth value of the fifth attribute (since the fifth attribute is not included in the set of authorized attributes, for example).

In some examples, at least some content of the PSAP emergency message 122 is converted to human-readable content (e.g., text that is-readable and/or understandable by a human) to generate an emergency message for transmission to an emergency contact. For example, the first emergency message 114 comprises the human-readable content to allow a recipient of the first emergency message 114 (e.g., the first emergency contact 108) to understand the first emergency message 114.

In some examples, the set of emergency contacts may include a support agent associated with an entity (e.g., a commercial entity, a company, etc.). The user of the UE 102 may be an employee of the entity, and/or the vehicle may be a commercial vehicle used by the entity for commercial operations (e.g., delivery, transportation, etc.). Thus, an emergency message (of the set of emergency messages) provided to the support agent of the entity may notify the support agent of the vehicular accident and/or may identify the vehicle (that may be in need of immediate support). Thus, the support agent of the entity may be able to allocate resources to the user and/or the vehicle involved in the vehicular accident in response to the emergency message.

In some examples, the network 104 triggers one or more emergency response operations in response to the emergency communication session request 112 (and/or determines that the emergency communication session request 112 is associated with an eCall) based upon the emergency communication session request 112 comprising an eCall indicator. In some examples, a Request-Uniform Resource Identifier (R-URI) of the emergency communication session request 112 comprises the eCall indicator. In some examples, the emergency communication session request 112 comprises a Session Initiation Protocol (SIP) invite request, and/or the R-URI may be in a request line of the SIP invite request. The one or more emergency response operations may comprise (i) establishing the communication session 118, (ii) providing an emergency message (e.g., the first emergency message 114, the second emergency message 116, etc.) to the set of emergency contacts, and/or (iii) providing the PSAP emergency message 122 to the first PSAP 106. In an example, the eCall indicator (in the R-URI) may comprise at least one of “urn: service: sos.ecall”, “urn: service: sos.ecall.automatic”, “urn: service: sos.ecall.manual”, etc.

In some examples, the emergency communication session request 112 is routed via a first control function (e.g., Serving Call Session Control Function (S-CSCF)) of the network 104, which may ensure that the emergency communication session request 112 is routed to a first application server (e.g., Rich Communication Suite Application Server (RCS-AS)) of the network 104. In some examples, an IP Multimedia Subsystem (IMS) (e.g., IMS core) of the network 104 comprises the first control function (e.g., the S-CSCF) and/or the first application server (e.g., the RCS-AS). In an example, the first control function (e.g., the S-CSCF) may comprise an initial Filter Criteria (iFC) (for IMS emergency registration, for example), which may trigger the first application server to retrieve the first subscriber profile from the subscriber profile database (e.g., the HSS). In an example, the first control function (e.g., the S-CSCF) may trigger the first application server to retrieve the first subscriber profile from the subscriber profile database (e.g., the HSS) based upon the R-URI of the emergency communication session request 112 (e.g., the SIP invite request) comprising the eCall indicator. In some examples, the first application server (e.g., the RCS-AS) may generate an emergency message (e.g., the first emergency message 114, the second emergency message 116, etc.) based upon the first subscriber profile retrieved from the subscriber profile database (e.g., the HSS). In some examples, based upon the R-URI (e.g., based upon the R-URI comprising the eCall indicator), the first application server (e.g., the RCS-AS) may proxy the emergency communication session request 112 (e.g., the SIP invite request) back to the first control function (e.g., the S-CSCF) to set up the communication session 118 (and/or perform the one or more emergency response operations). Alternatively and/or additionally, the first application server (e.g., the RCS-AS) may provide a SIP message to the first control function (e.g., the S-CSCF). The SIP message may comprise the emergency message (e.g., the first emergency message 114, the second emergency message 116, etc.). The SIP message may include a Resource Priority Header (RPH) with an emergency indication (e.g., an esnet namespace in accordance with RFC 7135). Network elements of the network 104 may prioritize the SIP message over other messages based upon the RPH having the emergency indication (e.g., to ensure that the emergency message is sent out with higher priority in case of overload). In some examples, if the first application server (e.g., the RCS-AS) is not available, the S-CSCF may establish the communication session 118.

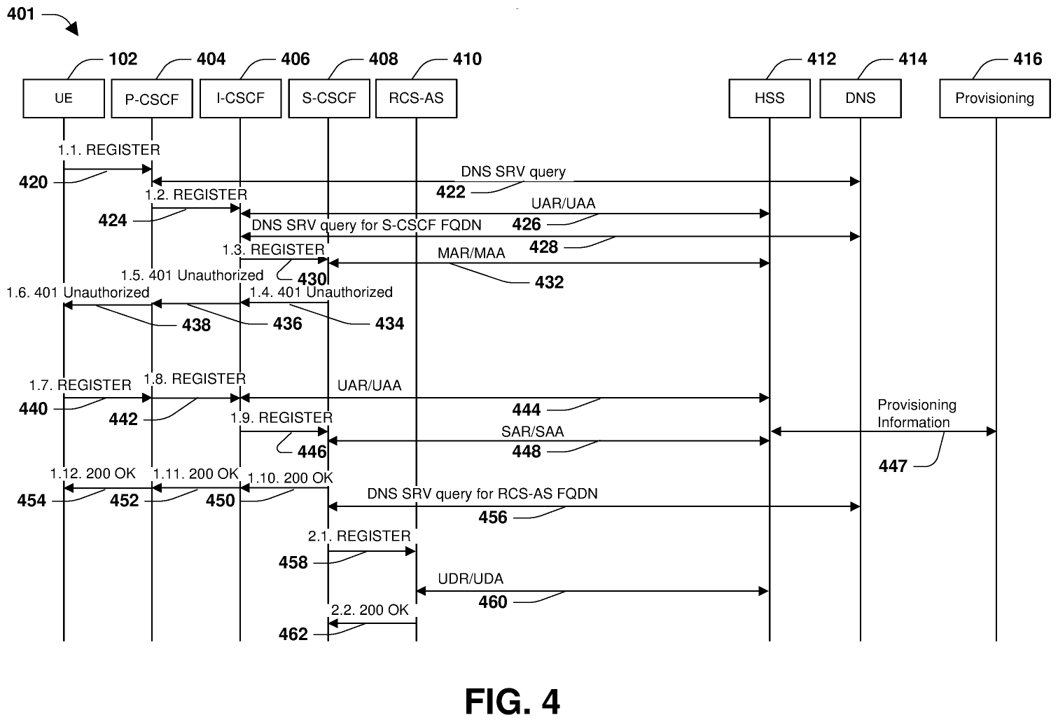

FIG. 4 illustrates a scenario associated with registration of the UE 102 with the network 104 in a system 401. In some examples, the network 104 comprises at least some of the system 401. For example, the registration may correspond to IMS emergency registration with the IMS of the network 104. The IMS may comprise a Proxy Call Session Control Function (P-CSCF) 404, an Interrogating Call Session Control Function (I-CSCF) 406, an S-CSCF 408 (e.g., the first control function), and/or an RCS-AS 410 (e.g., the first application server). The UE 102 may transmit a register message 420 to the P-CSCF 404. For example, the UE 102 may transmit the register message 420 after (and/or in response to) (i) attaching to the network 104 and/or (ii) establishing an emergency Packet Data Network (PDN) connection with the network 104. The P-CSCF 404 may perform (based upon the register message 420, for example) a Domain Name Server (DNS) Service record (SRV record) query 422 with a DNS 414 of the network 104. The P-CSCF 404 may transmit a register message 424 to the I-CSCF 406. The I-CSCF 406 may communicate a User-Authorization-Request (UAR) and/or a User-Authorization-Answer (UAA) 426 with an HSS 412 (e.g., the subscriber profile database) of the network 104. The I-CSCF 406 may perform a DNS SRV record query 428 (for S-CSCF fully qualified domain name (FQDN), for example) with the DNS 414. The I-CSCF 406 may transmit a register message 430 to the S-CSCF 408. The S-CSCF 408 may communicate a Multimedia-Authorization-Request (MAR) and/or a Multimedia-Authorization-Answer (MAA) 432 with the HSS 412 (e.g., the subscriber profile database) of the network 104. The S-CSCF 408 may transmit a 401 unauthorized message 434 to the I-CSCF 406. The I-CSCF 406 may transmit a 401 unauthorized message 436 to the P-CSCF 404. The P-CSCF 404 may transmit a 401 unauthorized message 438 to the UE 102. The UE 102 may transmit a register message 440 to the P-CSCF 404. The P-CSCF 404 may transmit a register message 442 to the I-CSCF 406. The I-CSCF 406 may communicate a UAR and/or a UAA 444 with the HSS 412 (e.g., the subscriber profile database) of the network 104. The I-CSCF 406 may transmit a register message 446 to the S-CSCF 408. The S-CSCF 408 may communicate a Server-Assignment-Request (SAR) and/or a Server-Assignment-Answer (SAA) 448 with the HSS 412 (e.g., the subscriber profile database) of the network 104. The S-CSCF 408 may transmit a 200 OK message 450 (e.g., a success status code) to the I-CSCF 406. The I-CSCF 406 may transmit a 200 OK message 452 (e.g., a success status code) to the P-CSCF 404. The P-CSCF 404 may transmit a 200 OK message 454 (e.g., a success status code) to the UE 102. The S-CSCF 408 may perform a DNS SRV record query 456 (for RCS-AS FQDN, for example) with the DNS 414. The S-CSCF 408 may transmit a register message 458 to the RCS-AS 410. The RCS-AS 410 may communicate a User-Data-Request (UDR) and/or a User-Data-Answer (UDA) 460 with the HSS 412 (e.g., the subscriber profile database) of the network 104. The RCS-AS 410 may transmit a 200 OK message 462 (e.g., a success status code) to the S-CSCF 408.

In some examples, the HSS 412 may communicate with a provisioning system 416 to acquire provisioning information 447 from the provisioning system 416. In some examples, the provisioning system 416 displays the emergency alert provisioning interface 350 (shown in FIG. 3) used to provision the set of emergency contacts of the UE 102 and/or the set of attributes to the first subscriber profile. The provisioning information 447 may comprise at least some of the emergency alert provisioning information received via the emergency alert provisioning interface 350. The first subscriber profile may be generated and/or stored in the HSS 412 (e.g., the subscriber profile database) based upon the provisioning information 447.

In some examples, the register message 458 transmitted by the S-CSCF 408 to the RCS-AS 410 may trigger (using the iFC, for example) the RCS-AS 410 to retrieve the first subscriber profile from the HSS 412. For example, the RCS-AS 410 may receive the first subscriber profile from the HSS 412 via the UDR and/or the UDA 460 (e.g., the UDA, which may be received by the RCS-AS 410 from the HSS 412, may comprise the first subscriber profile).

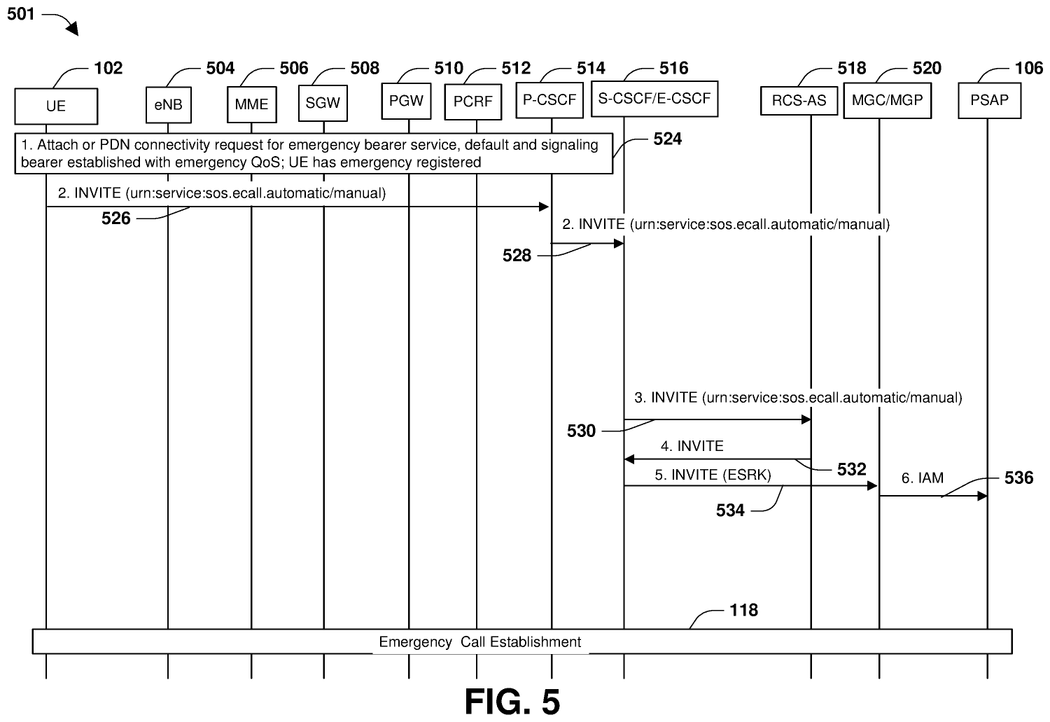

FIG. 5 illustrates a scenario associated with establishing the communication session 118 in a system 501. In some examples, the network 104 comprises at least some of the system 501. The system 501 may comprise the UE 102, an eNB 504, Mobility Management Entity (MME) 506, a Serving Gateway (SGW) 508, a Packet Gateway (PGW) 510, a Policy Charging and Rules Function (PCRF) 512, a P-CSCF 514, an S-CSCF/E-CSCF 516, an RCS-AS 518 (e.g., the first application server), a Media Gateway Controller (MGC)/Media Gateway Plane (MGP) 520, and/or the first PSAP 106. In some examples, the MGC/MGP 520 may provide an interface between network elements and/or interworking between SIP and Integrated Services Digital Network (ISDN) User Part (ISUP). In some examples, the S-CSCF/E-CSCF 516 may comprise a S-CSCF and/or an E-CSCF, wherein the first control function may comprise the S-CSCF (and/or the E-CSCF) of the S-CSCF/E-CSCF 516. In some examples, the UE 102, the eNB 504, the MME 506, the SGW 508, the PGW 510, the PCRF 512 and/or the P-CSCF 514 may perform one or more operations 524 to (i) attaching to the network 104, (ii) submitting a PDN connectivity request for an emergency bearer service, (iii) establishing a default and/or signaling bearer with emergency Quality of Service (QOS), (iv) registering the vehicular accident associated with the UE 102 (e.g., using one or more of the techniques shown in and/or described with respect to FIG. 4). The one or more operations 524 may comprise (and/or may be performed in conjunction with) one, some and/or all operations shown in and/or described with respect to FIG. 4. The UE 102 may transmit an invite 526 (e.g., a SIP invite) to the P-CSCF 514. The UE 102 may transmit the invite 526 (to initiate the eCall, for example) using one or more SOS sub-services (e.g., SOS.ecall.automatic” or “SOS.ecall.manual”) in the R-URI of the invite 526. The P-CSCF 514 may transmit an invite 528 (e.g., a SIP invite) to the S-CSCF/E-CSCF 516. The S-CSCF/E-CSCF 516 may transmit an invite 530 (e.g., a SIP invite) to the RCS-AS 518. In some examples, the invite 528 may trigger (using the iFC, for example) the S-CSCF/E-CSCF 516 to send the invite 530 to the RCS-AS 518. The RCS-AS 518 may transmit an invite 532 (e.g., a SIP invite) to the S-CSCF/E-CSCF 516. The S-CSCF/E-CSCF 516 may transmit an invite 534 (e.g., a SIP invite comprising an Emergency Services Routing Key (ESRK)) to the MGC/MGP 520. In some examples, the emergency communication session request 112 is included in the invite 526, the invite 528, the invite 530, the invite 532 and/or the invite 534. In some examples, the MGC/MGP 520 transmits an Initial Address Message (IAM) 536 to the PSAP 106 (in response to receiving the invite 534, for example). In some examples, the IAM 536 is an ISUP message (e.g., an ISUP IAM message). In some examples, for processing of the emergency communication session request 112, the RCS-AS 518 transmits the emergency communication session request 112 (e.g., the invite 532) back to the S-CSCF/E-CSCF 516 such that the emergency communication session request 112 and/or the IAM 536 are transmitted to the first PSAP 106 (to set up the communication session 118, for example). The RCS-AS 518 may trigger transmission of an emergency message (e.g., the first emergency message 114, the second emergency message 116, etc.) to the set of emergency contacts based upon the emergency communication session request 112 (e.g., the invite 530) comprising the eCall indicator. The communication session 118 (e.g., a voice call) may be established (in response to and/or subsequent to the IAM 536 being provided to the first PSAP 106, for example).

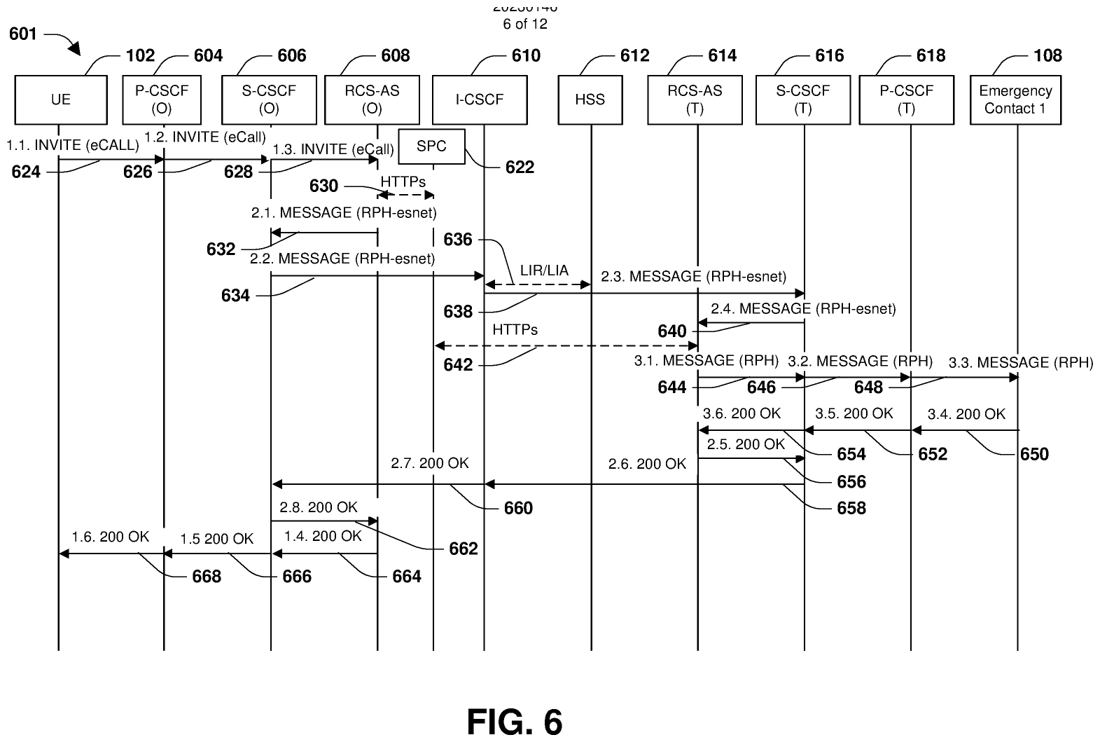

FIG. 6 illustrates a scenario associated with establishing the communication session 118 in a system 601. In some examples, the network 104 comprises at least some of the system 501. The system 501 may comprise the UE 102, a P-CSCF (O) 604, an S-CSCF (O) 606, an RCS-AS (O) 608, a Service Communication Proxy (SPC) 622, an I-CSCF 610, an RCS-AS (T) 614, an S-CSCF (T) 616, a P-CSCF (T) 618 and/or the first emergency contact 108. The P-CSCF (O) 604, the S-CSCF (O) 606, and/or the RCS-AS (O) 608 (and/or other components) may be part of an originating network (e.g., an originating telecommunication site, a base station, a gNB, an eNB, etc.) to which the UE 102 is connected (e.g., proximately connected). The RCS-AS (T) 614, the S-CSCF (T) 616 and/or the P-CSCF (T) 618 may be part of a second network (e.g., a terminating and/or transit network, a telecommunication site, a base station, a gNB, an eNB, etc.) to which the first emergency contact 108 is connected (e.g., proximately connected).

The UE 102 may transmit an invite 624 (e.g., a SIP invite comprising the eCall indicator) to the P-CSCF (O) 604, which may transmit an invite 626 (e.g., a SIP invite comprising the eCall indicator) to the S-CSCF (O) 606, which may transmit an invite 628 (e.g., a SIP invite comprising the eCall indicator) to the RCS-AS (O) 608. The emergency communication session request 112 may be included in the invite 624, the invite 626 and/or the invite 628. The invite 624, the invite 626 and/or the invite 628 may correspond to (e.g., may be the same as) at least some invites shown in FIG. 5, such as the invite 526, the invite 528, the invite 530, the invite 532 and/or the invite 534. The RCS-AS (O) 608 may perform communication 630 (e.g., Hypertext Transfer Protocol Secure (HTTPS) communication) with the SPC 622. The RCS-AS (O) 608 may be enhanced to translate at least some of the PSAP emergency message 122 (e.g., MSD) to the first emergency message 114 for transmission to the first emergency contact 108. The RCS-AS (O) 608 may generate a message 632 and/or transmit the message 632 to the S-CSCF (O) 606. The S-CSCF (O) 606 may transmit a message 634 to the I-CSCF 610. The I-CSCF 610 may communicate 636 (e.g., a Location Info Request (LIR) and/or a Location Info Answer (LIA)) with the HSS 612 and/or may transmit a message 638 to the S-CSCF (T) 616. The S-CSCF (T) 616 may transmit a message 640 to the RCS-AS (T) 614. The RCS-AS (T) 614 may perform communication 642 (e.g., HTTPS communication) with the SPC 622 and/or may transmit a message 644 to the S-CSCF (T) 616, which may transmit a message 646 to the P-CSCF (T) 616, which may transmit a message 648 to the first emergency contact 108. Each message of messages 632, 634, 638, 640, 644, 646 and/or 648 may include a RPH with an emergency indication (e.g., an esnet namespace) (such that network elements of the system 601 prioritize the message over other messages, for example). At least a portion of the first emergency message 114 is included in messages 632, 634, 638, 640, 644, 646 and/or 648. In some examples, one or more messages of the messages 632, 634, 638, 640, 644, 646 and/or 648 may be sent over transports that implement end-to-end congestion control, such as Transmission Control Protocol (TCP) and/or Stream Control Transmission Protocol (SCTP). The RCS-AS (O) 608 may facilitate transmission of the one or more messages over such transports (with end-to-end congestion control) based upon presence of an eCall service Uniform Resource Name (URN) (e.g., at least one of “urn: service: sos.ecall”, “urn: service: sos.ecall.automatic”, “urn: service: sos.ecall.manual”, etc.) in the invite 628. In some examples, OK messages 650, 652, 654, 656, 658, 660, 662, 664, 666 and/or 668 may be sent and/or received by components of the system 601.

In some examples, at least some of the communications shown in FIG. 5 (to establish the communication session 118, for example) may be performed concurrently with at least some of the communications shown in FIG. 6 (to send the first emergency message 114 to the first emergency contact 108, for example).

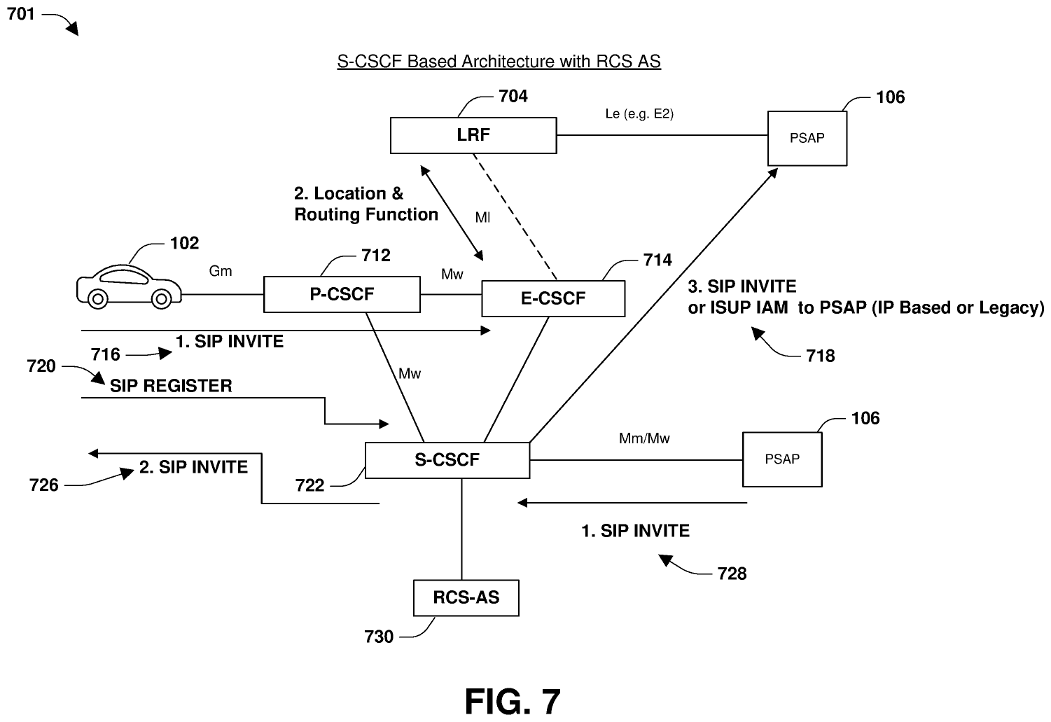

FIG. 7 illustrates a S-CSCF-based network architecture of a system 701 comprising an S-CSCF 722 (e.g., the first control function). In some examples, the S-CSCF-based network architecture is implemented by the network 104 (and/or the network 104 comprises the system 701). In some examples, the emergency communication session request 112 is included in SIP invite 716, SIP invite 726, SIP invite 728 and/or component 718 (e.g., the component 718 may comprise at least one of a SIP invite, an ISUP IAM message, etc.). The system 701 may comprise a Location Retrieval Function (LRF) 704, which may provide one or more location (and/or routing) services and/or may communicate with the first PSAP 106 and/or an Emergency Call Session Control Function (E-CSCF) 714 of the system 701 (e.g., the LRF 704 may determine the location of the UE 102 and/or may provide the location to the first PSAP 106, for example). The first PSAP 106 may query the LRF 704 for the location of the UE 102. The system 701 may comprise a P-CSCF 712, which may communicate with the UE 102, the E-CSCF 714 and/or the S-CSCF 722. The P-CSCF 712 and/or the E-CSCF 714 may receive the SIP invite 716. The S-CSCF 722 may (i) receive a SIP register 720, (ii) transmit the SIP invite 726, (iii) receive the SIP invite 728 (from the first PSAP 106, for example), and/or (iv) transmit the component 718 to the first PSAP 106. The system 701 may comprise an RCS-AS 730 (e.g., the first application server) and/or one or more other application servers which may provide one or more services for subscribers (e.g., the user of the UE 102) of a telecommunication service provider associated with the system 701 and/or the network 104. Example interfaces and/or protocols (e.g., Gm, Mw, etc.) for communication between network elements of the system 701 are shown in FIG. 7.

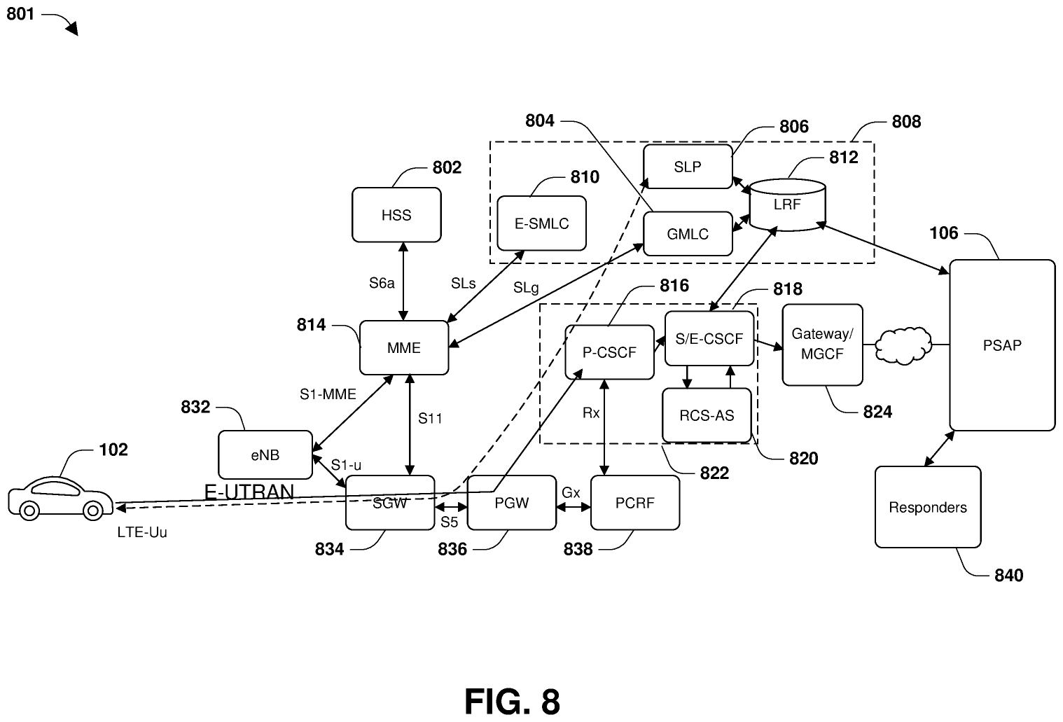

FIG. 8 illustrates a network architecture of a system 801 for emergency services, such as 4G Voice over LTE (VOLTE) emergency services. Example interfaces and/or protocols (e.g., Gx, S5, etc.) for communication between network elements of the system 801 are shown in FIG. 8. In some examples, the network 104 comprises at least some of the system 801. The system 801 may comprise a SGW 834, a PGW 836, an MME 814, an HSS 802 (e.g., the subscriber profile database), a PCRF 838, an IMS 822, a set of emergency service network elements 808, and/or a gateway/Media Gateway Control Function (MGCF) 824. The IMS 822 may comprise a P-CSCF 816, a S/E-CSCF 818, and/or an RCS-AS 820. In some examples, the S/E-CSCF 818 may comprise a S-CSCF and/or an E-CSCF, wherein the first control function may comprise the S-CSCF (and/or the E-CSCF) of the S/E-CSCF 818. The first application server may comprise the RCS-AS 820. The set of emergency service network elements 808 may comprise an Evolved Serving Mobile Location Center (E-SMLC) 810, a Secure User Plane Location (SUPL) Location Platform (SLP) 806, a Gateway Mobile Location Center (GMLC) 804, and/or an LRF 812. In some examples, the set of emergency service network elements 808 may be used to determine the location of the UE 102 and/or to provide the location to the first PSAP 106. The first PSAP 106 may query the LRF 812 for the location of the UE 102. In some examples, the first PSAP 106 may dispatch responders 840 (e.g., emergency medical personnel, firefighters, police, manpower, etc.) to the location of the UE 102.

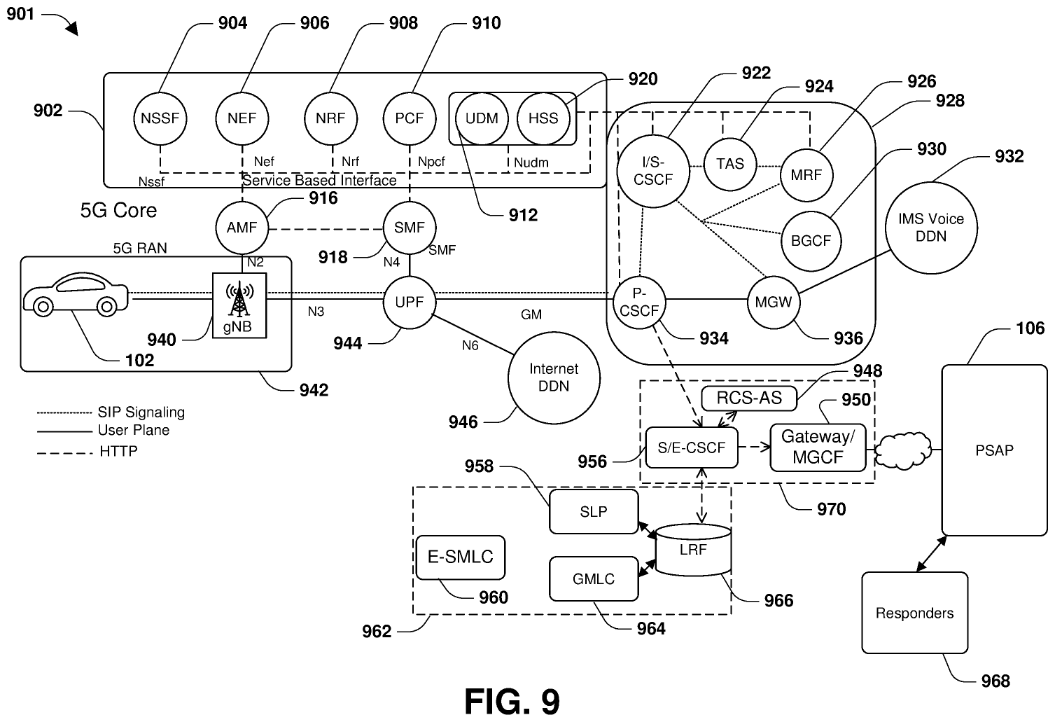

FIG. 9 illustrates a network architecture of a system 901 for emergency services, such as 5G Voice over NR (VoNR) emergency services. Example interfaces and/or protocols (e.g., SIP signaling, User Plane, Hypertext Transfer Protocol (HTTP), Npcf, etc.) for communication between network elements of the system 901 are shown in FIG. 9. In some examples, the network 104 comprises at least some of the system 901. The system 901 may comprise a core network 902 (e.g., 5G Core), 5G RAN 942 (comprising the UE 102 and/or a gNB 940), a set of network elements 928, a set of emergency service network elements 962, an Access and Mobility Management Function (AMF) 916, a Session Management Function (SMF) 918, a User Plane Function (UPF) 944, a Data Network Name (DDN) 946 (e.g., Internet DDN), an IMS 970 and/or an IMS Voice DDN 932. The core network 902 may comprise a Network Slice Selection Function (NSSF) 904, a Network Exposure Function (NEF) 906, a Network Repository Function (NRF) 908, a Policy Control Function (PCF) 910, a Unified Data Management (UDM) 912 and/or an HSS 920 (e.g., the subscriber profile database). The set of network elements 928 may comprise an I/S-CSCF 922, a Telephony Application Server (TAS) 924, a Multimedia Resource Function (MRF) 926, a Breakout Gateway Control Function (BGCF) 930, a Media Gateway (MGW) 936 and/or a P-CSCF 934. In some examples, the I/S-CSCF 922 may comprise a S-CSCF and/or an I-CSCF, wherein the first control function may comprise the S-CSCF (and/or the I-CSCF) of the I/S-CSCF 922. The IMS 970 may comprise a S/E-CSCF 956, an RCS-AS 948 and/or a gateway/MGCF 950. In some examples, the S/E-CSCF 956 may comprise a S-CSCF and/or an E-CSCF, wherein the first control function may comprise the S-CSCF (and/or the E-CSCF) of the S/E-CSCF 956. The set of emergency service network elements 962 may comprise an E-SMLC 960, a SLP 958, a GMLC 964, and/or an LRF 966. In some examples, the first PSAP 106 may dispatch responders 968 (e.g., emergency medical personnel, firefighters, police, manpower, etc.) to the location of the UE 102 based upon information (e.g., geolocation information indicative of the location of the UE 102) provided by the set of emergency service network elements 962.

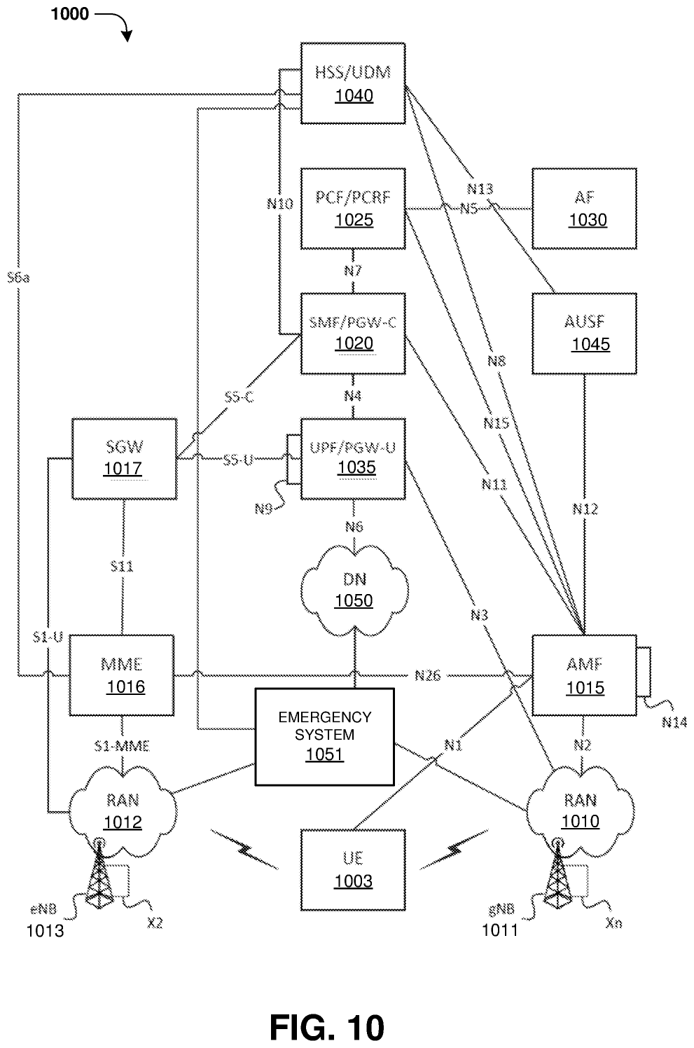

FIG. 10 illustrates an example environment 1000, in which one or more embodiments may be implemented. In some embodiments, environment 1000 may correspond to a Fifth Generation (“5G”) network, and/or may include elements of a 5G network. In some embodiments, environment 1000 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). As shown, environment 1000 may include UE 1003, RAN 1010 (which may include one or more Next Generation Node Bs (“gNBs”) 1011), RAN 1012 (which may include one or more one or more evolved Node Bs (“eNBs”) 1013), and various network functions such as Access and Mobility Management Function (“AMF”) 1015, Mobility Management Entity (“MME”) 1016, Serving Gateway (“SGW”) 1017, Session Management Function (“SMF”)/Packet Data Network (“PDN”) Gateway (“PGW”)-Control plane function (“PGW-C”) 1020, Policy Control Function (“PCF”)/Policy Charging and Rules Function (“PCRF”) 1025, Application Function (“AF”) 1030, User Plane Function (“UPF”)/PGW-User plane function (“PGW-U”) 1035, Home Subscriber Server (“HSS”)/Unified Data Management (“UDM”) 1040, and Authentication Server Function (“AUSF”) 1045. Environment 1000 may also include one or more networks, such as Data Network (“DN”) 1050. Environment 1000 may include one or more additional devices or systems communicatively coupled to one or more networks (e.g., DN 1050), such as emergency system 1051.

The example shown in FIG. 10 illustrates one instance of each network component or function (e.g., one instance of SMF/PGW-C 1020, PCF/PCRF 1025, UPF/PGW-U 1035, HSS/UDM 1040, and/or 1045). In practice, environment 1000 may include multiple instances of such components or functions. For example, in some embodiments, environment 1000 may include multiple “slices” of a core network, where each slice includes a discrete set of network functions (e.g., one slice may include a first instance of SMF/PGW-C 1020, PCF/PCRF 1025, UPF/PGW-U 1035, HSS/UDM 1040, and/or 1045, while another slice may include a second instance of SMF/PGW-C 1020, PCF/PCRF 1025, UPF/PGW-U 1035, HSS/UDM 1040, and/or 1045). The different slices may provide differentiated levels of service, such as service in accordance with different Quality of Service (“QoS”) parameters.

The quantity of devices and/or networks, illustrated in FIG. 10, is provided for explanatory purposes only. In practice, environment 1000 may include additional devices and/or networks, fewer devices and/or networks, different devices and/or networks, or differently arranged devices and/or networks than illustrated in FIG. 10. For example, while not shown, environment 1000 may include devices that facilitate or enable communication between various components shown in environment 1000, such as routers, modems, gateways, switches, hubs, etc. Alternatively and/or additionally, one or more of the devices of environment 1000 may perform one or more network functions described as being performed by another one or more of the devices of environment 1000. Devices of environment 1000 may interconnect with each other and/or other devices via wired connections, wireless connections, or a combination of wired and wireless connections. In some implementations, one or more devices of environment 1000 may be physically integrated in, and/or may be physically attached to, one or more other devices of environment 1000.

UE 1003 may include a computation and communication device, such as a wireless mobile communication device that is capable of communicating with RAN 1010, RAN 1012, and/or DN 1050. UE 1003 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, or the like), a wearable device, an Internet of Things (“IoT”) device, a Mobile-to-Mobile (“M2M”) device, or another type of mobile computation and communication device. UE 1003 may send traffic to and/or receive traffic (e.g., user plane traffic) from DN 1050 via RAN 1010, RAN 1012, and/or UPF/PGW-U 1035.

RAN 1010 may be, or may include, a 5G RAN that includes one or more base stations (e.g., one or more gNBs 1011), via which UE 1003 may communicate with one or more other elements of environment 1000. UE 1003 may communicate with RAN 1010 via an air interface (e.g., as provided by gNB 1011). For instance, RAN 1010 may receive traffic (e.g., voice call traffic, data traffic, messaging traffic, signaling traffic, etc.) from UE 1003 via the air interface, and may communicate the traffic to UPF/PGW-U 1035, and/or one or more other devices or networks. Similarly, RAN 1010 may receive traffic intended for UE 1003 (e.g., from UPF/PGW-U 1035, AMF 1015, and/or one or more other devices or networks) and may communicate the traffic to UE 1003 via the air interface.

RAN 1012 may be, or may include, a LTE RAN that includes one or more base stations (e.g., one or more eNBs 1013), via which UE 1003 may communicate with one or more other elements of environment 1000. UE 1003 may communicate with RAN 1012 via an air interface (e.g., as provided by eNB 1013). For instance, RAN 1010 may receive traffic (e.g., voice call traffic, data traffic, messaging traffic, signaling traffic, etc.) from UE 1003 via the air interface, and may communicate the traffic to UPF/PGW-U 1035, and/or one or more other devices or networks. Similarly, RAN 1010 may receive traffic intended for UE 1003 (e.g., from UPF/PGW-U 1035, SGW 1017, and/or one or more other devices or networks) and may communicate the traffic to UE 1003 via the air interface.

AMF 1015 may include one or more devices, systems, Virtualized Network Functions (“VNFs”), etc., that perform operations to register UE 1003 with the 5G network, to establish bearer channels associated with a session with UE 1003, to hand off UE 1003 from the 5G network to another network, to hand off UE 1003 from the other network to the 5G network, manage mobility of UE 1003 between RANs 1010 and/or gNBs 1011, and/or to perform other operations. In some embodiments, the 5G network may include multiple AMFs 1015, which communicate with each other via the N14 interface (denoted in FIG. 10 by the line marked “N14” originating and terminating at AMF 1015).

MME 1016 may include one or more devices, systems, VNFs, etc., that perform operations to register UE 1003 with the EPC, to establish bearer channels associated with a session with UE 1003, to hand off UE 1003 from the EPC to another network, to hand off UE 1003 from another network to the EPC, manage mobility of UE 1003 between RANs 1012 and/or eNBs 1013, and/or to perform other operations.

SGW 1017 may include one or more devices, systems, VNFs, etc., that aggregate traffic received from one or more eNBs 1013 and send the aggregated traffic to an external network or device via UPF/PGW-U 1035. Additionally, SGW 1017 may aggregate traffic received from one or more UPF/PGW-Us 1035 and may send the aggregated traffic to one or more eNBs 1013. SGW 1017 may operate as an anchor for the user plane during inter-eNB handovers and as an anchor for mobility between different telecommunication networks or RANs (e.g., RANs 1010 and 1012).

SMF/PGW-C 1020 may include one or more devices, systems, VNFs, etc., that gather, process, store, and/or provide information in a manner described herein. SMF/PGW-C 1020 may, for example, facilitate in the establishment of communication sessions on behalf of UE 1003. In some embodiments, the establishment of communications sessions may be performed in accordance with one or more policies provided by PCF/PCRF 1025.

PCF/PCRF 1025 may include one or more devices, systems, VNFs, etc., that aggregate information to and from the 5G network and/or other sources. PCF/PCRF 1025 may receive information regarding policies and/or subscriptions from one or more sources, such as subscriber databases and/or from one or more users (such as, for example, an administrator associated with PCF/PCRF 1025).

AF 1030 may include one or more devices, systems, VNFs, etc., that receive, store, and/or provide information that may be used in determining parameters (e.g., quality of service parameters, charging parameters, or the like) for certain applications.

UPF/PGW-U 1035 may include one or more devices, systems, VNFs, etc., that receive, store, and/or provide data (e.g., user plane data). For example, UPF/PGW-U 1035 may receive user plane data (e.g., voice call traffic, data traffic, etc.), destined for UE 1003, from DN 1050, and may forward the user plane data toward UE 1003 (e.g., via RAN 1010, SMF/PGW-C 1020, and/or one or more other devices). In some embodiments, multiple UPFs 1035 may be deployed (e.g., in different geographical locations), and the delivery of content to UE 1003 may be coordinated via the N9 interface (e.g., as denoted in FIG. 10 by the line marked “N9” originating and terminating at UPF/PGW-U 1035). Similarly, UPF/PGW-U 1035 may receive traffic from UE 1003 (e.g., via RAN 1010, SMF/PGW-C 1020, and/or one or more other devices), and may forward the traffic toward DN 1050. In some embodiments, UPF/PGW-U 1035 may communicate (e.g., via the N4 interface) with SMF/PGW-C 1020, regarding user plane data processed by UPF/PGW-U 1035.

HSS/UDM 1040 and AUSF 1045 may include one or more devices, systems, VNFs, etc., that manage, update, and/or store, in one or more memory devices associated with AUSF 1045 and/or HSS/UDM 1040, profile information associated with a subscriber. AUSF 1045 and/or HSS/UDM 1040 may perform authentication, authorization, and/or accounting operations associated with the subscriber and/or a communication session with UE 1003.

DN 1050 may include one or more wired and/or wireless networks. For example, DN 1050 may include an Internet Protocol (“IP”)-based PDN, a wide area network (“WAN”) such as the Internet, a private enterprise network, and/or one or more other networks. UE 1003 may communicate, through DN 1050, with data servers, other UEs UE 1003, and/or to other servers or applications that are coupled to DN 1050. DN 1050 may be connected to one or more other networks, such as a public switched telephone network (“PSTN”), a public land mobile network (“PLMN”), and/or another network. DN 1050 may be connected to one or more devices, such as content providers, applications, web servers, and/or other devices, with which UE 1003 may communicate.

The emergency system 1051 may include one or more devices, systems, VNFs, etc., that perform one, some and/or all operations described herein. For example, the emergency system 1051 may establish the communication session 118, provide the PSAP emergency message 122 to the first PSAP 106, and/or provide the set of emergency messages to the set of emergency contacts.

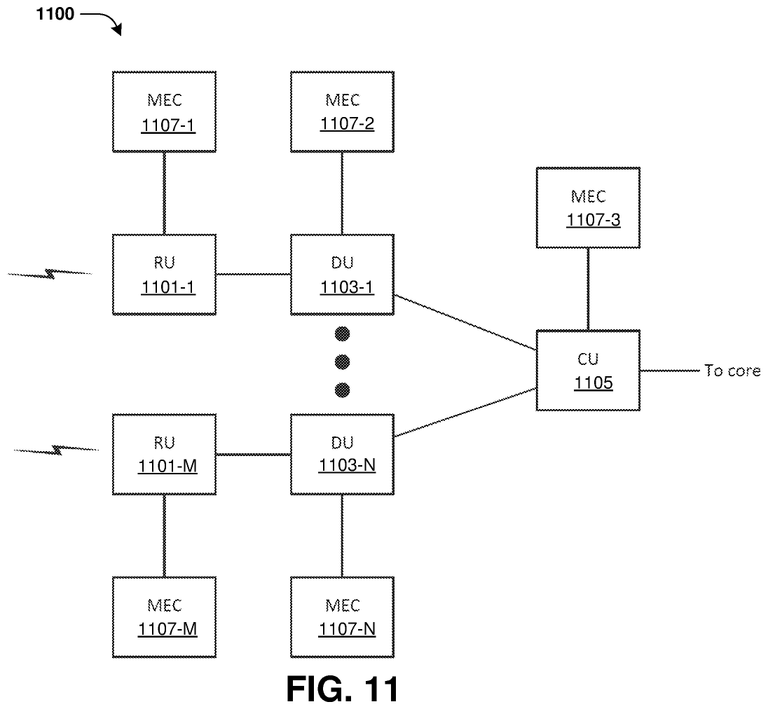

FIG. 11 illustrates an example Distributed Unit (“DU”) network 1100, which may be included in and/or implemented by one or more RANs (e.g., RAN 1010, RAN 1012, or some other RAN). In some embodiments, a particular RAN may include one DU network 1100. In some embodiments, a particular RAN may include multiple DU networks 1100. In some embodiments, DU network 1100 may correspond to a particular gNB 1011 of a 5G RAN (e.g., RAN 1010). In some embodiments, DU network 1100 may correspond to multiple gNBs 1011. In some embodiments, DU network 1100 may correspond to one or more other types of base stations of one or more other types of RANs. As shown, DU network 1100 may include Central Unit (“CU”) 1105, one or more Distributed Units (“DUs”) 1103-1 through 1103-N (referred to individually as “DU 1103,” or collectively as “DUs 1103”), and one or more Radio Units (“RUs”) 1101-1 through 1101-M (referred to individually as “RU 1101,” or collectively as “RUs 1101”).

CU 1105 may communicate with a core of a wireless network (e.g., may communicate with one or more of the devices or systems described above with respect to FIG. 10, such as AMF 1015 and/or UPF/PGW-U 1035). In the uplink direction (e.g., for traffic from UEs UE 1003 to a core network), CU 1105 may aggregate traffic from DUs 1103, and forward the aggregated traffic to the core network. In some embodiments, CU 1105 may receive traffic according to a given protocol (e.g., Radio Link Control (“RLC”)) from DUs 1103, and may perform higher-layer processing (e.g., may aggregate/process RLC packets and generate Packet Data Convergence Protocol (“PDCP”) packets based upon the RLC packets) on the traffic received from DUs 1103.

In accordance with some embodiments, CU 1105 may receive downlink traffic (e.g., traffic from the core network) for a particular UE 1003, and may determine which DU(s) 1103 should receive the downlink traffic. DU 1103 may include one or more devices that transmit traffic between a core network (e.g., via CU 1105) and UE 1003 (e.g., via a respective RU 1101). DU 1103 may, for example, receive traffic from RU 1101 at a first layer (e.g., physical (“PHY”) layer traffic, or lower PHY layer traffic), and may process/aggregate the traffic to a second layer (e.g., upper PHY and/or RLC). DU 1103 may receive traffic from CU 1105 at the second layer, may process the traffic to the first layer, and provide the processed traffic to a respective RU 1101 for transmission to UE 1003.

RU 1101 may include hardware circuitry (e.g., one or more RF transceivers, antennas, radios, and/or other suitable hardware) to communicate wirelessly (e.g., via an RF interface) with one or more UEs UE 1003, one or more other DUs 1103 (e.g., via RUs 1101 associated with DUs 1103), and/or any other suitable type of device. In the uplink direction, RU 1101 may receive traffic from UE 1003 and/or another DU 1103 via the RF interface and may provide the traffic to DU 1103. In the downlink direction, RU 1101 may receive traffic from DU 1103, and may provide the traffic to UE 1003 and/or another DU 1103.

RUs 1101 may, in some embodiments, be communicatively coupled to one or more Multi-Access/Mobile Edge Computing (“MEC”) devices, referred to sometimes herein simply as (“MECs”) 1107. For example, RU 1101-1 may be communicatively coupled to MEC 1107-1, RU 1101-M may be communicatively coupled to MEC 1107-M, DU 1103-1 may be communicatively coupled to MEC 1107-2, DU 1103-N may be communicatively coupled to MEC 1107-N, CU 1105 may be communicatively coupled to MEC 1107-3, and so on. MECs 1107 may include hardware resources (e.g., configurable or provisionable hardware resources) that may be configured to provide services and/or otherwise process traffic to and/or from UE 1003, via a respective RU 1101.

For example, RU 1101-1 may route some traffic, from UE 1003, to MEC 1107-1 instead of to a core network (e.g., via DU 1103 and CU 1105). MEC 1107-1 may process the traffic, perform one or more computations based upon the received traffic, and may provide traffic to UE 1003 via RU 1101-1. In this manner, ultra-low latency services may be provided to UE 1003, as traffic does not need to traverse DU 1103, CU 1105, and an intervening backhaul network between DU network 1100 and the core network. In some embodiments, MEC 1107 may include, and/or may implement some or all of the functionality described above with respect to at least one of the emergency system 1051, the system 101, the method 200, the system 401, the system 501, the system 601, the system 701, the system 801, the system 901, etc.

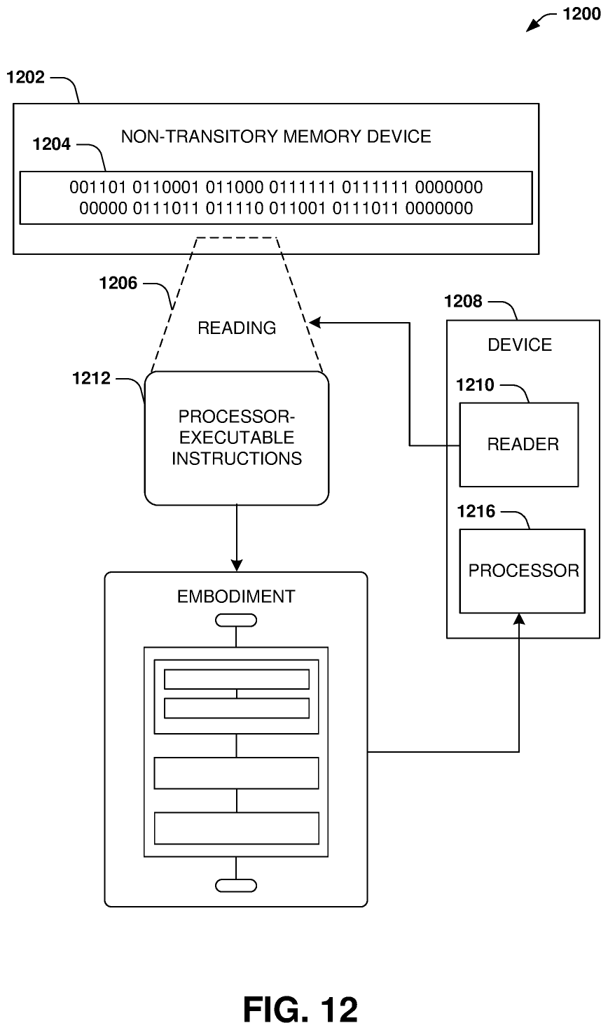

FIG. 12 is an illustration of a scenario 1200 involving an example non-transitory machine-readable medium 1202. The non-transitory machine-readable medium 1202 may comprise processor-executable instructions 1212 that when executed by a processor 1216 cause performance (e.g., by the processor 1216) of at least some of the provisions herein. The non-transitory machine-readable medium 1202 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine-readable medium 1202 stores computer-readable data 1204 that, when subjected to reading 1206 by a reader 1210 of a device 1208 (e.g., a read head of a hard disk drive, or a read operation invoked on a solid-state storage device), express the processor-executable instructions 1212. In some embodiments, the processor-executable instructions 1212, when executed cause performance of operations, such as at least some of the example method 200 of FIG. 2, for example. In some embodiments, the processor-executable instructions 1212 are configured to cause implementation of a system, such as at least some of the example system 101 of FIG. 1, at least some of the example system 401 of FIG. 4, at least some of the example system 501 of FIG. 5, at least some of the example system 601 of FIG. 6, at least some of the example system 701 of FIG. 7, at least some of the example system 801 of FIG. 8 and/or at least some of the example system 901 of FIG. 9, for example.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer-readable instructions stored on one or more computer-readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed is:

1. A method, comprising:
receiving, from a first user equipment (UE), an emergency communication session request; and
in response to the emergency communication session request:
establishing a communication session between the first UE and a first public safety answering point (PSAP);
retrieving a first subscriber profile, associated with the first UE, from a subscriber profile database;
determining, based upon the first subscriber profile, a destination address of an emergency contact of the first UE and a first attribute associated with the emergency contact; and
providing, based upon the first attribute, a first emergency message to the destination address of the emergency contact.

2. The method of claim 1, wherein:
the emergency communication session request is received in response to a vehicular accident associated with the first UE.

3. The method of claim 1, wherein:
the first UE is an in-vehicle system (IVS) UE of a vehicle involved in a vehicular accident.

4. The method of claim 1, wherein:
establishing the communication session and providing the first emergency message are performed concurrently.

5. The method of claim 1, comprising:
in response to the emergency communication session request, providing a second emergency message to the first PSAP.

6. The method of claim 1, wherein:
the destination address of the emergency contact comprises a mobile directory number (MDN) of the emergency contact; and
providing the first emergency message to the destination address of the emergency contact comprises transmitting a text message to the MDN.

7. The method of claim 1, wherein:
the first subscriber profile indicates authorization to share the first attribute with the emergency contact; and
the method comprises:
determining a value corresponding to the first attribute; and
generating the first emergency message to include the value.

8. The method of claim 7, wherein:
the emergency communication session request is received in response to a vehicular accident of a vehicle; and
the first attribute corresponds to at least one of:
a quantity of occupants of the vehicle;
a time of the vehicular accident;
a location of the vehicular accident;
a travel direction of the vehicle; or
a vehicle description of the vehicle.

9. The method of claim 7, comprising:
generating a second emergency message to include the value corresponding to the first attribute; and
providing the second emergency message to the first PSAP.

10. The method of claim 1, comprising:
displaying an emergency alert provisioning interface;
receiving, via the emergency alert provisioning interface, an emergency contact entry indicative of the destination address of the emergency contact;
generating the first subscriber profile, associated with the first UE, to include the emergency contact based upon the emergency contact entry; and
storing the first subscriber profile in the subscriber profile database.

11. The method of claim 1, wherein:
the communication session corresponds to at least one of a voice call or a video call.

12. A non-transitory computer-readable medium storing instructions that when executed perform operations comprising:
receiving, from a first user equipment (UE), an emergency communication session request; and
in response to the emergency communication session request:
establishing a communication session between the first UE and a first public safety answering point (PSAP); and
providing a first emergency message to an emergency contact of the first UE.

13. The non-transitory computer-readable medium of claim 12, wherein:
the emergency communication session request is received in response to a vehicular accident associated with the first UE.

14. The non-transitory computer-readable medium of claim 12, wherein:
the first UE is an in-vehicle system (IVS) UE of a vehicle involved in a vehicular accident.

15. The non-transitory computer-readable medium of claim 12, wherein:
establishing the communication session and providing the first emergency message are performed concurrently.

16. The non-transitory computer-readable medium of claim 12, the operations comprising:
in response to the emergency communication session request, providing a second emergency message to the first PSAP.

17. The non-transitory computer-readable medium of claim 12, the operations comprising:
in response to the emergency communication session request, retrieving a first subscriber profile, associated with the first UE, from a subscriber profile database; and
determining the emergency contact of the first UE based upon the first subscriber profile.

18. The non-transitory computer-readable medium of claim 17, wherein:
providing the first emergency message to the emergency contact comprises transmitting a text message to a mobile directory number (MDN), of the emergency contact, indicated by the first subscriber profile.

19. An emergency system comprising a processor configured to:
receive, from a first user equipment (UE), an emergency communication session request; and
in response to the emergency communication session request:
establish a communication session between the first UE and a first public safety answering point (PSAP); and
provide a first emergency message to an emergency contact of the first UE.

20. The system of claim 19, wherein:
the communication session corresponds to at least one of a voice call or a video call.
